(19) United States
(12) Patent Application Publication
(10) Pub. No.: US 2025/0365560 A1
(43) Pub. Date: Nov. 27, 2025

(54) BROADCAST SERVICE AREA IN EARTH MOVING CELLS

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US); Dalin Zhu, Allen, TX (US)

(21) Appl. No.: 19/291,483

(22) Filed: Aug. 5, 2025

Related U.S. Application Data
(60) Provisional application No. 63/684,185, filed on Aug. 16, 2024.
(60) Provisional application No. 63/697,212, filed on Sep. 20, 2024.
(60) Provisional application No. 63/701,971, filed on Oct. 1, 2024.

(51) Int. Cl. H04W 4/06; H04B 7/185; H04W 64/00

(52) U.S. Cl. CPC H04W 4/06; H04B 7/18554; H04W 64/00

(57) ABSTRACT

Disclosed are signalling designs for configuring intended service area for an earth moving cell in an NTN and methods for a UE to receive MBS broadcast service. A UE receives from a base station intended service area information for one or more broadcast services of a moving cell. The intended service area information for a broadcast service includes time information to indicate when the moving cell provides the broadcast service in the intended service areas. The UE determines an intended service area of a target broadcast service among the one or more broadcast services of the moving cell based on the intended service area information associated with the target broadcast service. The UE determines a location of the UE. The UE determines to receive the target broadcast service from the moving cell based on the intended service area of the target broadcast service and the location of the UE.

### CROSS-REFERENCE TO RELATED APPLICATIONS

This application claims the benefit of priority from U.S. Provisional Application No. 63/684,185 entitled “BROADCAST SERVICE AREA IN EARTH MOVING CELLS,” filed Aug. 16, 2024, U.S. Provisional Application No. 63/701,971 entitled “BROADCAST SERVICE AREA IN EARTH MOVING CELLS,” filed Oct. 1, 2024, and U.S. Provisional Application No. 63/697,212 entitled “ACTIVATION OF CSI RESOURCE FOR MOBILITY,” filed Sep. 20, 2024, all of which are incorporated herein by reference in their entirety.

### TECHNICAL FIELD

This disclosure relates generally to a wireless communication system, and more particularly to techniques for signaling a multicast/broadcast services (MBS) service area for an earth moving cell in a non-terrestrial network (NTN).

### BACKGROUND

3GPP (Third-Generation Partnership Project) has developed technical specifications and standards to define the new 5G radio-access technology, known as 5G NR (New Radio) and the upcoming technology currently coined “6G.” In 3GPP Release 17 specification, 5G NR introduces support for vertical functionality of a non-terrestrial network (NTN). An NTN provides non-terrestrial NR access to a user equipment (UE) by means of an NTN payload, e.g. a satellite, and an NTN Gateway as specified in 3GPP TS 38.300 v18.0.0 (5G; NR; NR and NG-RAN Overall Descriptions; Stage 2) and 3GPP TS 38.331 v18.0.0 (5G; NR; Radio Resource Control (RRC); Protocol specification). The NTN payload transparently forwards the radio protocol received from the UE over the service link (i.e. wireless link between the NTN payload and UE) to the NTN Gateway (via the feeder link, i.e. wireless link between the NTN Gateway and the NTN payload) and vice-versa. With its capabilities to deliver wide coverage and reliable connectivity, NTN is envisioned to provide ubiquitous service availability and continuity. For instance, NTN can support communication services in unserved areas beyond the reach of conventional terrestrial networks (TN), in underserved areas with limited communication services, for devices and passengers on board moving platforms, and in future railway/maritime/aeronautical communication scenarios, etc. To support NTN in 5G NR, features are continuously being introduced or enhanced to accommodate the nature of radio access to NTN such as large cell coverage, long propagation delay, and non-static cell/satellite that are different from TN.

In TN, a serving cell may broadcast common data to all UEs within the cell via multicast/broadcast services (MBS). In contrast, an NTN features satellite footprints that typically cover areas much larger than those covered by TN cells. The intended broadcast area in NTN may be smaller than an NTN cell coverage area and the broadcast information may be specific to UEs in a certain region within an NTN earth moving cell. Therefore, it is desired to design signalling for the intended service area of MBS for an earth moving cell in NTN.

While the background section provides a motivation for the present disclosure, the description set forth in the background section should not be assumed to be prior art merely because it is set forth in the background section. Rather, the background section may describe aspects or embodiments of the present disclosure.

### SUMMARY

An aspect of the present disclosure provides for a user equipment (UE) in a wireless network. The UE includes a processor configured to receive from a base station intended service area information for one or more broadcast services of a moving cell. The intended service area information for respective broadcast services includes time information to indicate when the moving cell provides the respective broadcast services in respective intended service areas. The processor is also configured to determine an intended service area of a target broadcast service among the one or more broadcast services of the moving cell based on the intended service area information associated with the target broadcast service. The processor is further configured to determine a location of the UE. The processor is further configured to determine whether to receive the target broadcast service from the moving cell based on the intended service area of the target broadcast service and the location of the UE.

In one embodiment, to determine the intended service area of the target broadcast service, the processor is configured to determine a time interval when the moving cell provides the target broadcast service in a geographic area based on the intended service area information for the target broadcast service.

In one embodiment of the UE, to determine whether to receive the target broadcast service from the moving cell, the processor is configured to determine the location of the UE is within the geographic area of the target broadcast service. The processor is also configured to determine a current time is within the time interval. The processor is further configured to receive the target broadcast service.

In one embodiment of the UE, to determine whether to receive the target broadcast service from the moving cell, the processor is configured to determine the location of the UE is outside the geographic area of the target broadcast service or a current time is outside the time interval. The processor is also configured to refrain from receiving the target broadcast service.

In one embodiment of the UE, the intended service area information for the one or more broadcast services includes cell coverage area information of the moving cell. The cell coverage area information includes a center location of the cell coverage area at a reference time and a radius of the cell coverage area.

In one embodiment of the UE, to determine the intended service area of the target broadcast service, the processor is configured to determine a center location of the cell coverage area at a target time based on the center location of the cell coverage area at the reference time and satellite ephemeris data associated with the moving cell. The processor is also configured to determine the cell coverage area at the target time based on the center location of the cell coverage area at the target time and the radius of the cell coverage area.

In one embodiment of the UE, to determine whether to receive the target broadcast service from the moving cell, the processor is configured to determine the location of the UE is within the intended service area of the target broadcast service at the target time. The processor is also configured to determine the location of the UE is within the cell coverage area at the target time. The processor is further configured to receive the target broadcast service at the target time.

In one embodiment of the UE, to determine whether to receive the target broadcast service from the moving cell, the processor is configured to determine the location of the UE is outside the intended service area of the target broadcast service at the target time or outside the cell coverage area at the target time. The processor is also configured to refrain from receiving the target broadcast service at the target time.

In one embodiment of the UE, the intended service area information for the respective one or more broadcast services includes a center location of a geographic area of the respective one or more broadcast services at a reference time and a radius of the geographic area of the respective one or more broadcast services.

In one embodiment of the UE, to determine the intended service area of the target broadcast service, the processor is configured to determine a center location of the geographic area of the target broadcast service at a target time based on the center location of the geographic area of the target broadcast service at the reference time and satellite ephemeris data associated with the moving cell. The processor is also configured to determine the geographic area of the target broadcast service at the target time based on the center location of the geographic area of the target broadcast service at the target time and the radius of the geographic area of the target broadcast service.

An aspect of the present disclosure provides for a method performed by a UE in a wireless network. The method includes the UE receiving, from a base station, intended service area information for one or more broadcast services of a moving cell. The intended service area information for respective broadcast services including time information to indicate when the moving cell provides the respective broadcast services in respective intended service areas. The method also includes the UE determining an intended service area of a target broadcast service among the one or more broadcast services of the moving cell based on the intended service area information associated with the target broadcast service. The method further includes the UE determining a location of the UE and determining whether to receive the target broadcast service from the moving cell based on the intended service area of the target broadcast service and the location of the UE.

In one embodiment of the method, when determining the intended service area of the target broadcast service, the method includes the UE determining a time interval when the moving cell provides the target broadcast service in a geographic area based on the intended service area information for the target broadcast service.

In one embodiment of the method, when determining whether to receive the target broadcast service from the moving cell, the method includes the UE determining the location of the UE is within the geographic area of the target broadcast service. The method also includes the UE determining a current time is within the time interval. The method further includes the UE receiving the target broadcast service.

In one embodiment of the method, when determining whether to receive the target broadcast service from the moving cell, the method includes the UE determining the location of the UE is outside the geographic area of the target broadcast service or a current time is outside the time interval. The method also includes the UE refraining from receiving the target broadcast service.

In one embodiment of the method, the intended service area information for the one or more broadcast services includes cell coverage area information of the moving cell. The cell coverage area information includes a center location of the cell coverage area at a reference time and a radius of the cell coverage area.

In one embodiment of the method, when determining the intended service area of the target broadcast service, the method includes the UE determining a center location of the cell coverage area at a target time based on the center location of the cell coverage area at the reference time and satellite ephemeris data associated with the moving cell. The method also includes the UE determining the cell coverage area at the target time based on the center location of the cell coverage area at the target time and the radius of the cell coverage area.

In one embodiment of the method, when determining whether to receive the target broadcast service from the moving cell, the method includes the UE determining the location of the UE is within the intended service area of the target broadcast service at the target time. The method also includes the UE determining the location of the UE is within the cell coverage area at the target time. The method further includes the UE receiving the target broadcast service at the target time.

In one embodiment of the method, when determining whether to receive the target broadcast service from the moving cell, the method includes the UE determining the location of the UE is outside the intended service area of the target broadcast service at the target time or outside the cell coverage area at the target time. The method also includes the UE refraining from receiving the target broadcast service.

In one embodiment of the method, the intended service area information for the respective one or more broadcast services includes a center location of a geographic area of the respective one or more broadcast services at a reference time and a radius of the geographic area of the respective one or more broadcast services.

In one embodiment of the method, when determining the intended service area of the target broadcast service, the method includes the UE determining a center location of the geographic area of the target broadcast service at a target time based on the center location of the geographic area of the target broadcast service at the reference time and satellite ephemeris data associated with the moving cell. The method also includes the UE determining the geographic area of the target broadcast service at the target time based on the center location of the geographic area of the target broadcast service at the target time and the radius of the geographic area of the target broadcast service.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows a procedure for a UE to receive MBS broadcast service in an intended service area in accordance with an embodiment.

FIG. 5 shows a procedure for a UE to receive MBS broadcast service in an intended service area in accordance with another embodiment.

FIG. 6 shows a procedure for a UE to receive MBS broadcast service in an intended service area in accordance with yet another embodiment.

FIG. 7 shows a procedure for a UE to implement periodic early CSI reporting in accordance with an embodiment.

FIG. 8 shows a procedure for a UE to implement semi-persistent early CSI reporting in accordance with an embodiment.

FIG. 9 shows a procedure for a UE to implement aperiodic early CSI reporting in accordance with an embodiment.

FIG. 10 shows fields of the CSI resource set activation/deactivation MAC CE in accordance with an embodiment

FIG. 11 shows an example process 1100 for a UE to receive MBS broadcast service from the base station of a moving cell based on the UE location and the intended service area of the MBS broadcast service in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic that has dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

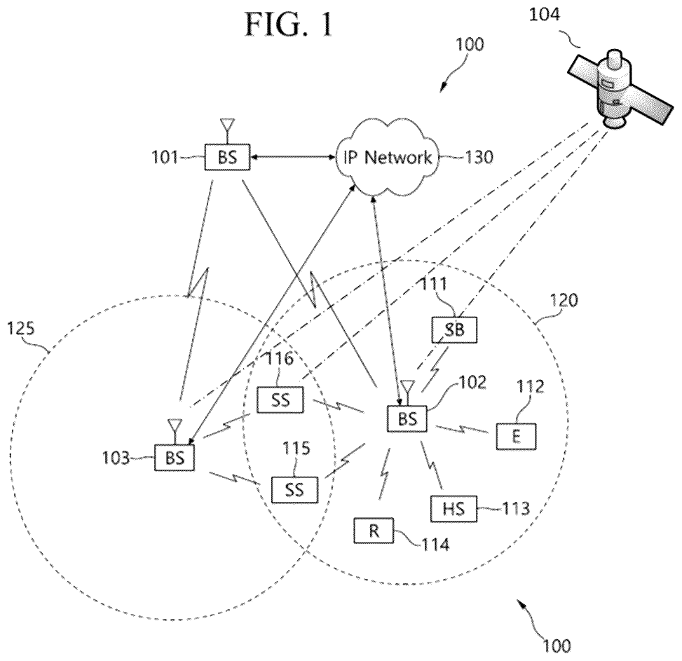

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the BS 101, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

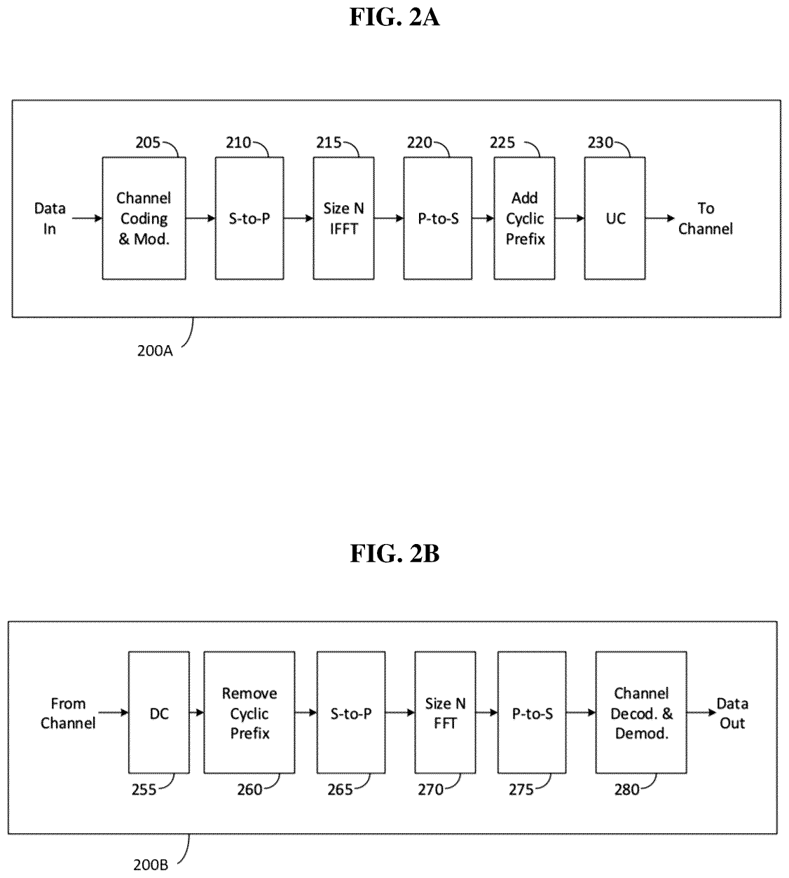

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

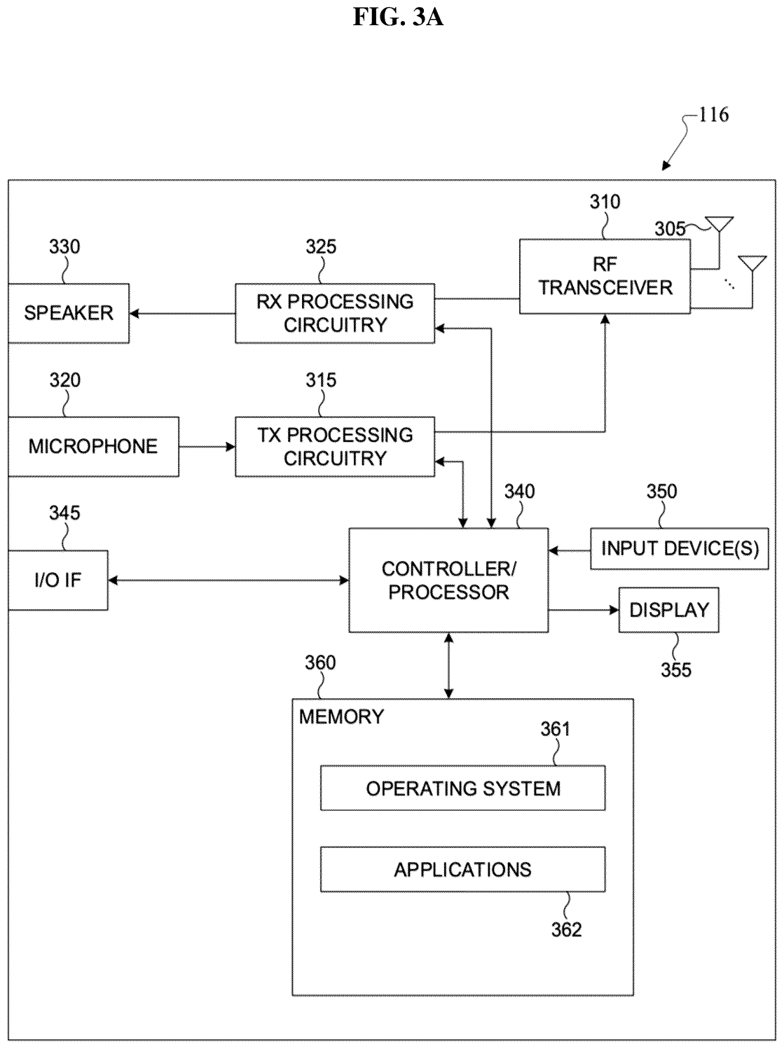

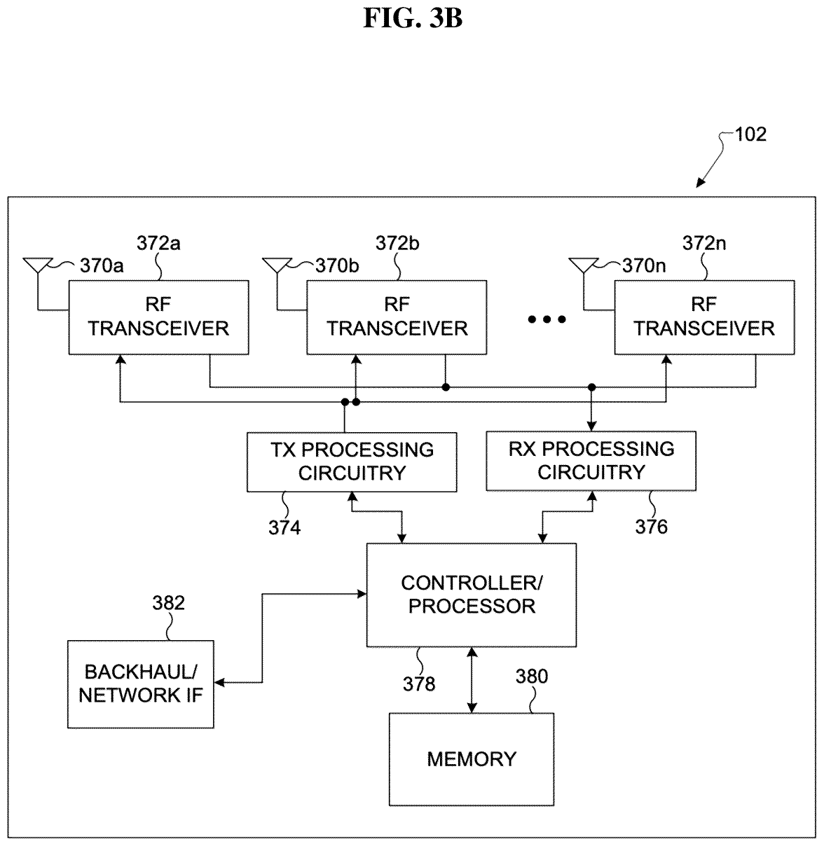

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 is coupled to the processor 340, directly or through intervening elements. The main processor 340 is also capable of executing other processes and programs resident in the memory 360 as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main processor 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting other processes in wireless communication systems as described in embodiments of the present disclosure. In some embodiments, the controller/processor 378 supports communications between entities, such as web real-time communication (web RTC). The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning the uplink transmission to a certain frequency and establishing the downlink transmission using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one TX processing circuitry 374 or RX processing circuitry 376 per RF transceiver).

As an example, Release13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For 5G and the next generation cellular systems such as 6G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs) —or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP, TS 38.300 v18.0.0, ii) 3GPP TS 38.331 v18.0.0; iii) 3GPP TS 38.321 v18.0.0; iv) 3GPP, TS 38.304 v18.2.0; and v) 3GPP, TS 38.306 v18.2.0.

In NTN, the NTN payload may be in geosynchronous orbit (GSO) (i.e. earth-centered orbit at approximately 35,786 kilometers above Earth's surface and synchronized with Earth's rotation), or in non-geosynchronous orbit (NGSO) (i.e. Low Earth Orbit (LEO) at altitude approximately between 300 km and 1,500 km or Medium Earth Orbit (MEO) at altitude approximately between 7000 km and 25,000 km). Depending on different NTN payloads, three types of service links are supported:
Earth-fixed: provisioned by beam(s) continuously covering the same geographical areas all the time (e.g., the case of GSO satellites);
Quasi-Earth-fixed: provisioned by beam(s) covering one geographic area for a limited period and a different geographic area during another period (e.g., the case of NGSO satellites generating steerable beams); and
Earth-moving: provisioned by beam(s) whose coverage area slides over the Earth surface (e.g., the case of NGSO satellites generating fixed or non-steerable beams).

With NGSO satellites, the gNB may provide either quasi-Earth-fixed cell coverage or Earth-moving cell coverage, while gNB operating with GSO satellite may provide Earth fixed cell coverage. A UE may support specific features or functionalities for radio access specific to a NTN payload/cell.

NR system enables resource efficient delivery of multicast/broadcast services (MBS). For broadcast communication service, the gNB provide the same service and the same specific content data simultaneously to all UEs in a geographical area (i.e., all UEs in the broadcast service area as defined in 3GPP Specification TS 23.247 are authorized to receive the data). The gNB delivers a broadcast communication service using a broadcast session. A UE may receive a broadcast communication service in RRC_IDLE, RRC_INACTIVE and RRC_CONNECTED state.

The UE may receive the MBS configuration for a broadcast session (e.g., parameters needed for multicast traffic channel (MTCH) reception) via multicast control channel (MCCH) in RRC_IDLE, RRC_INACTIVE and RRC_CONNECTED state. The UE may obtain the parameters needed for the reception of MCCH via System Information Block (SIB).

The following principles may govern the MCCH structure:
MCCH provides the list of all broadcast services with ongoing sessions transmitted on MTCH(s). The associated information for a broadcast session includes MBS session ID, associated group radio network temporary identifier (G-RNTI) scheduling information, and information about neighboring cells providing certain service on MTCH(s), etc. The gNB transmits MCCH content within periodically occurring time domain windows, referred to as MCCH transmission window defined by MCCH repetition period, MCCH window duration and radio frame/slot offset;
MCCH uses a modification period and MCCH contents are only allowed to be modified at each modification period boundary. A MCCH notification mechanism is used to announce the change of MCCH contents due to broadcast session start, modification or stop, and due to neighboring cell information modification. The UE may use the start and stop times in the MBS user service description (USD) to determine when to start monitoring the MCCH for the session the UE is interested in.
When the UE receives an MCCH change notification, the UE acquires the updated MCCH in the same MCCH modification period where the MCCH change notification is sent.

As mentioned, the intended broadcast area in NTN may be smaller than an NTN cell coverage area and the broadcast information may be specific to UEs in a certain region within an NTN earth moving cell. Disclosed are techniques for signalling intended service area for an earth moving cell in NTN. Additionally, disclosed are procedures for a UE to receive MBS broadcast service in an intended service area for an earth moving cell in NTN.

In one embodiment, a UE receives MBS broadcast intended service area information (e.g., in SIB) and/or MBS broadcast configuration containing MBS broadcast intended service area information (e.g., in MCCH) from the base station (e.g., gNB) for one or multiple serving cells and/or neighbour cells. The intended service area information and/or MBS broadcast configuration may include geographic area information and/or time information associated with the intended service area and/or NTN earth moving cell for one or more MBS broadcast service. The UE identifies its geographic location and the intend service area of an interested MBS broadcast service. The UE then receives the interested MBS broadcast service from the base station based on the MBS broadcast configuration when the identified geographic location of the UE is inside the intended service area of the interested MBS broadcast service and a measured time is within the time information associated with the intended service area.

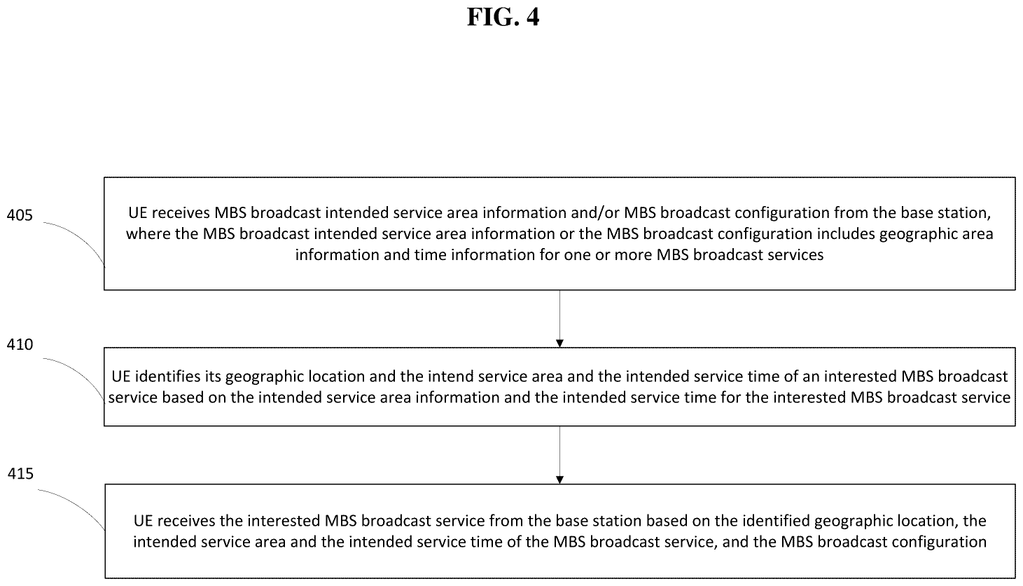

FIG. 4 shows a procedure for a UE to receive MBS broadcast service in an intended service area in accordance with an embodiment.

At operation 405, the UE receives MBS broadcast intended service areas information and/or MBS broadcast configuration from the base station for one or more MBS broadcast services (or MBS broadcast sessions). The broadcast intended service area information and/or the MBS broadcast configuration may include a list of geographic intended service areas and intended service time information. Each area may be identified by an MBS broadcast service area ID and associated with an MBS broadcast session that is provided for an MBS broadcast service. The MBS broadcast intended service area information may be provided in system information (e.g., in SIB) or in MCCH (e.g., in MBS broadcast configuration). When the MBS broadcast intended service area information is provided in SIB, each broadcast service (session) may be associated with a service area so that the UE may become aware of the intended service area of each broadcast service by acquiring the SIB only and skips acquiring MCCH.

In one embodiment, each geographic intended service area is characterized by centre coordinates (e.g., reference location) and a radius. The centre coordinates may be signalled as a bit string, in the format of Ellipsoid-Point defined in 3GPP Specification TS37.355. The first/leftmost bit of the first octet may contain the most significant bit. The radius may indicate a distance from the centre coordinates. In one embodiment, the distance may be signalled as an integer value in a unit of meter.

In one embodiment, an intended service area is characterized by a polygon as defined in 3GPP Specification TS23.032. A polygon is an arbitrary shape described by an ordered series of points. The minimum number of points allowed may be 3, and the maximum number of points allowed may be 15. The points may be connected in the order that they are given. A connecting line may be defined as the line over the ellipsoid joining the two points and of minimum distance (geodesic). The last point is connected to the first. The list of points may satisfy a number of conditions: (1) a connecting line does not cross another connecting line; and (2) two successive points are not diametrically opposed on the ellipsoid. The described area may be situated to the right of the lines with the downward direction being toward the Earth's centre and the forward direction being from a point to the next. In one embodiment, the polygon area is signalled in the format of Polygon defined in 3GPP Specification TS37.355.

In one embodiment, if an intended service area of a MBS broadcast service covers a whole cell, a one-bit indication may be provided for the associated MBS broadcast service. Alternatively, an MBS broadcast service that is intended to cover the whole cell may be grouped into a list (e.g., by listing the ID of the service) and communicated to the UE. In another embodiment, an MBS broadcast service may be associated with multiple geographic areas that cover a part of or the whole of a cell.

In one embodiment of an earth moving cell (e.g., serving and/or neighbour cell), intended service time information may be associated with an MBS broadcast session. The intended service time may be indicated by a start time and/or a duration and/or an end time. The duration may indicate a time interval from the start time during which the current cell provisions the MBS broadcast session in the indicated geographic intended service area. In one example, the duration may be indicated in units of millisecond or second.

The intended service start/end time may indicate when the current cell starts/stops to provision the MBS broadcast session in the indicated geographic intended service area. As an example, the start/end time of an intended geographic area may be indicated by as an absolute time, which is in multiples of 10 ms after 00:00:00 on Gregorian calendar date 1 Jan. 1900 (midnight between Sunday, Dec. 31, 1899 and Monday, Jan. 1, 1900). The exact stop time may be finer than 10 ms resolution. For example, the exact stop time may be between the time indicated by the value of this field minus 1 and the time indicated by the value of this field. The reference point for the start/end time may be the uplink time synchronization reference point of the NTN cell.

In another example, the intended service start/end time may be defined as the starting time of a downlink (DL) sub-frame which is nearest to the frame in which the UE receives the message indicating the start/end time, and the sub-frame may be indicated by a system frame number (SFN) and a sub-frame number. The reference point of the start/end time may be the uplink time synchronization reference point of the NTN cell.

In operation 410, if the UE is interested in the corresponding MBS broadcast service of a MBS broadcast session whose geographic intended service area is provided, the UE identifies its geographic location (e.g., by global navigation satellite system (GNSS)) and identifies the intended service area of the interested MBS broadcast service based on the geographic intended service area information associated with the MBS broadcast session. The UE may also identify the intended service time for the interested MBS broadcast service based on the intended service time information.

In operation 415, for the interested MBS broadcast service, if the UE identifies that it is inside the intended service area and the measured time is within the intended service time, the UE receives the MBS broadcast session based on the MBS broadcast configuration. For example, the UE may establish the multicast radio bearer (MRB(s)) for the MBS broadcast session and/or monitor physical downlink control channel (PDCCH) at the frequency/time resource allocated for the MBS broadcast session. If, for the interested MBS broadcast service, the UE identifies that it is outside/leaving the intended service area or the measured time is not within the intended service time, the UE may not receive the MBS broadcast session based on the MBS broadcast configuration. For example, the UE may release or not establish the MRB(s) for the MBS broadcast session and/or stop monitoring PDCCH at the frequency/time resource allocated for the MBS broadcast session.

In one embodiment, the base station may provide the cell coverage area information for an earth moving cell (e.g., serving or neighbour cell). The earth moving cell may be characterized by coverage area centre coordinates (e.g., reference location) at a reference time and a coverage area radius. The UE identifies its geographic location and the real-time cell coverage area of an interested MBS broadcast service of the earth moving cell. The UE then receives the interested MBS broadcast service from the base station based on MBS broadcast configuration when the identified geographic location of the UE is inside an intended service area of the MBS broadcast service and the intended service area of the MBS broadcast service overlaps with the real-time cell coverage area.

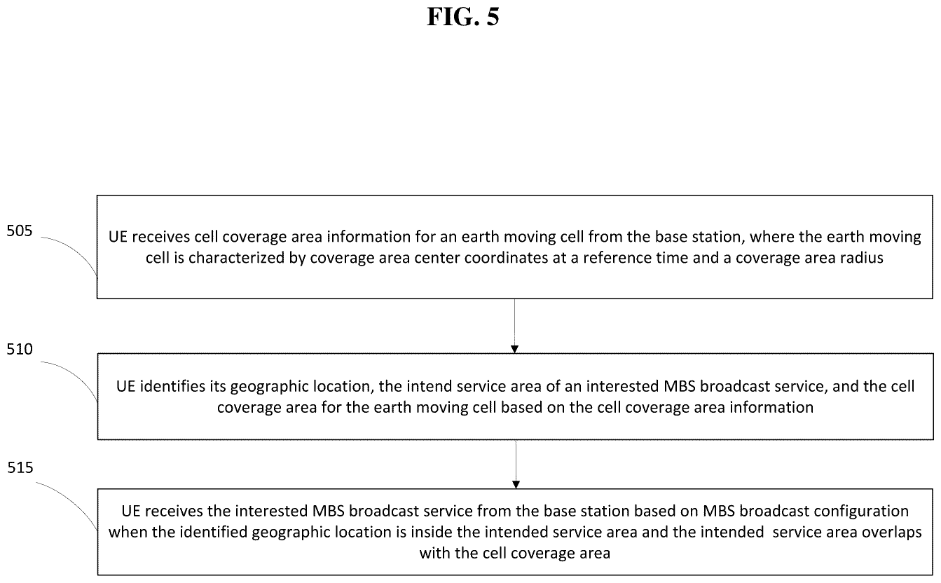

FIG. 5 shows a procedure for a UE to receive MBS broadcast service in an intended service area in accordance with another embodiment.

In operation 505, the UE receives from the base station cell coverage area information for an earth moving cell. The earth moving cell is characterized by coverage area centre coordinates at a reference time and a coverage area radius. The centre coordinates at a reference time may be signalled as a bit string, in the format of Ellipsoid-Point defined in 3GPP Specification TS37.355. The first/leftmost bit of the first octet may contain the most significant bit. The radius may indicate a distance from the centre coordinates. In one embodiment, the distance may be signalled as an integer value in a unit of meter. The UE may derive/estimate/determine the real-time coordinates of the cell coverage centre based on the centre coordinates at the reference time and the satellite ephemeris associated with the cell. In one embodiment, the cell may be identified by a physical layer cell identity (PCI) and/or frequency band (e.g., absolute radio frequency channel number (ARFCN)). In one embodiment, system information (e.g., SIB19) for a serving cell and/or a neighbour cell may provide the satellite ephemeris. The UE may derive/estimate/determine the real-time cell coverage area based on the real-time coordinates of the cell coverage centre and the coverage area radius.

In one embodiment, the UE may receive geographic intended service area information associated with an MBS broadcast session that is provided for an MBS broadcast service. The geographic intended service area information may be provided in system information (e.g., in SIB) or in MCCH (e.g., in MBS broadcast configuration).

In operation 510, if the UE is interested in the corresponding MBS broadcast service of an MBS broadcast session whose geographic intended service area is provided and the cell coverage area information for an earth moving cell (e.g., serving or neighbour cell) for the MBS broadcast service is also provided, the UE identifies its geographic location (e.g., by GNSS) and identifies the intended service area of the interested MBS broadcast service based on the geographic intended service area information associated with the MBS broadcast session. The UE also identifies the real-time cell coverage area for the earth moving cell based on the cell coverage area information. The UE determines whether the intend service area of the interested MBS broadcast session has overlapping area with the real-time cell coverage area.

In operation 515, for the interested MBS broadcast service, if the UE identifies that it is inside the intended service area and the intend service area has overlapping area with the real-time cell coverage area, the UE receives the MBS broadcast session based on MBS broadcast configuration. For example, the UE may establish the MRB(s) for the MBS broadcast session and/or monitor PDCCH at the frequency/time resource allocated for the MBS broadcast session. If, for the interested MBS service, the UE identifies that it is outside/leaving the intended service area or the intend service area has no overlapping area with the real-time cell coverage area, the UE may not receive the MBS broadcast session based on the MBS broadcast configuration. For example, the UE may release or not establish the MRB(s) for the MBS broadcast session and/or stop monitoring PDCCH at the frequency/time resource allocated for the MBS broadcast session.

In one embodiment, for an earth-moving cell, the intended service area for a MBS broadcast service or a MBS broadcast service may be characterized by centre coordinates (e.g., reference location) at a reference time and a radius. The UE identifies its geographic location and the real-time intend service area of an interested MBS broadcast service of the earth moving cell. The UE then receives the interested MBS broadcast service from the base station based on MBS broadcast configuration when the identified geographic location of the UE is inside the real-time intended service area of the interested MBS broadcast service.

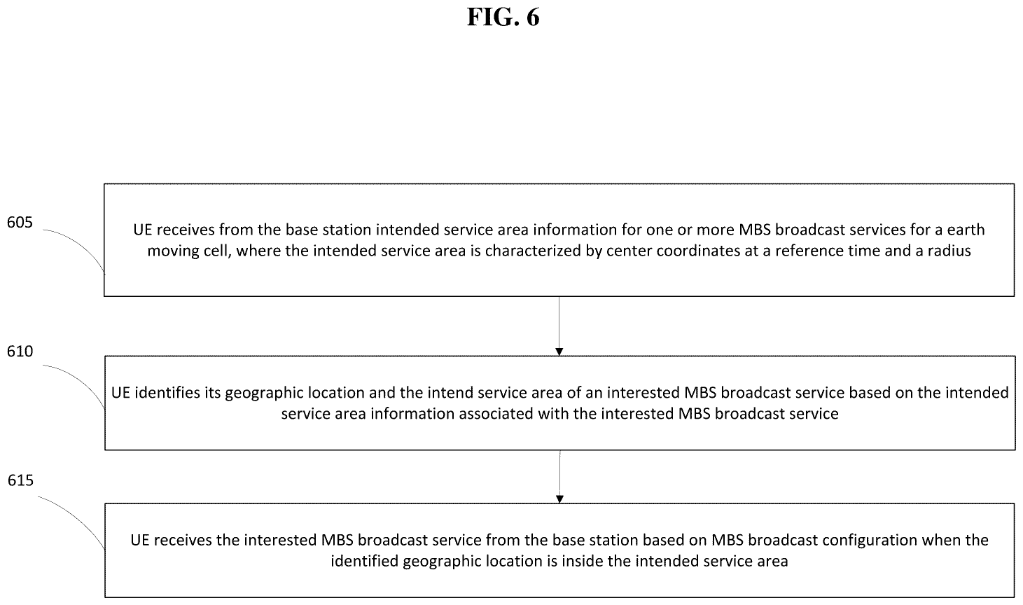

FIG. 6 shows a procedure for a UE to receive MBS broadcast service in an intended service area in accordance with yet another embodiment.

In operation 605, the UE receives from the base station intended service area information for one or more MBS broadcast services (or MBS broadcast sessions) for an earth moving cell. The intended service area information characterizes the geographic intended service area by centre coordinates (e.g., reference location) at a reference time and a radius. The centre coordinates at a reference time may be signalled as a bit string, in the format of Ellipsoid-Point defined in 3GPP Specification TS37.355. The first/leftmost bit of the first octet may contain the most significant bit. The radius may indicate a distance from the centre coordinates. In one embodiment, the distance may be signalled as an integer value in a unit of meter. The centre point of the geographic area is moving. The UE may derive/estimate/determine the real-time coordinates of the centre point based on the centre coordinates (e.g., reference location) at the reference time and the satellite ephemeris associated with the cell. In one embodiment, the cell may be identified by a PCI and/or frequency band (e.g., ARFCN). In one embodiment, system information (e.g., SIB 19) for a serving cell and/or a neighbour cell may provide the satellite ephemeris. The UE may derive/estimate/determine the real-time intended service area based on the real-time cell centre coordinates and the radius.

In operation 610, if the UE is interested in the corresponding MBS broadcast service of an MBS broadcast session whose geographic intended service area is provided for an earth moving cell (e.g., serving or neighbour cell), the UE identifies its geographic location (e.g., by GNSS) and identifies the real-time intended service area of the MBS broadcast service based on the geographic area information associated with the MBS broadcast session.

In operation 615, for the interested MBS service, if the UE identifies that it is inside the real-time intended service area, the UE receives the MBS broadcast session based on MBS broadcast configuration. For example, the UE may establish the MRB(s) for the MBS broadcast session and/or monitors PDCCH at the frequency/time resource allocated for the MBS broadcast session. If, for the interested MBS service, the UE identifies that it is outside/leaving the real-time intended service area, the UE may not receive the MBS broadcast session based on the MBS broadcast configuration. For example, the UE may release or not establish the MRB(s) for the MBS broadcast session and/or stop monitoring PDCCH at the frequency/time resource allocated for the MBS broadcast session.

In one embodiment, for service continuity of the UE in RRC_IDLE or RRC_INACTIVE state, the UE may perform cell reselection. For frequency prioritization in cell reselection, when the UE is no longer inside the intended service area or within the intended service time of interested MBS broadcast service(s), the UE may no longer prioritize the frequency providing these MBS broadcast service(s).

In one embodiment, if the MBS broadcast capable UE is receiving or interested in receiving an MBS broadcast service(s) and can only receive this MBS broadcast service(s) by camping on a frequency on which it is provided, the UE may consider that frequency to be the highest priority during the MBS broadcast session if the following conditions are fulfilled:
1) When intended service area/time information are provided for the MBS broadcast service, the UE is inside the intended service area or within the intended service time of the MBS broadcast session(s) corresponding to the receiving/interested MBS broadcast service;
2) SIB1 scheduling information of the cell reselected by the UE due to frequency prioritization for MBS contains SIB20; and
3) Either
   a. One or more MBS frequency specific area information (FSAI(s)) of that frequency is indicated in SIB21 of the serving cell and the same MBS FSAI(s) is also indicated for this MBS broadcast service in MBS User Service Description (USD) as specified in 3GPP Specification TS 26.517;
   b. SIB21 is not provided in the serving cell and that frequency is included in the USD of this MBS broadcast service; or
   c. SIB21 is provided in the serving cell but does not provide the frequency mapping for the MBS broadcast service, and that frequency is included in the USD of this MBS broadcast service. In one embodiment, when the USD provides multiple frequencies for the MBS broadcast service the UE is interested in, the UE determines which frequency to select.

In one embodiment, if the MBS broadcast capable UE is receiving or interested in receiving an MBS broadcast service, the UE may consider cell reselection candidate frequencies at which it cannot receive the MBS broadcast service to be of the lowest priority during the MBS broadcast session, if:
1) When intended service area/time information are provided for MBS broadcast service, the UE is outside the intended service area or not within the intended service time of the MBS broadcast session(s) corresponding to the receiving/interested MBS broadcast service;
2) SIB1 scheduling information of the cell contains SIB20 on the MBS frequency which the UE monitors; and
3) Condition 3) above is fulfilled for the serving cell.

In one embodiment, to ensure service continuity of MBS broadcast when the UE is in RRC_CONNECTED state, the UE may send MBS interest indication information to the gNB. The MBS interest indication information may consist of the following information:
List of MBS frequencies the UE is receiving or interested in receiving sorted in decreasing order of interest, for which the UE is inside the associated intended service area/time of the MBS broadcast service if configured;
Priority between the reception of all listed MBS frequencies and the reception of any unicast bearer and multicast MRB; and/or
List of MBS broadcast services the UE is receiving or interested in receiving, for which the UE is inside the associated intended service area/time if configured, in the case where SIB20 is provided for primary cell (PCell) or secondary cell (SCell).

In one embodiment, the presence or absence of SIB21 may implicitly enable or disable the MBS interest indication information reporting. The gNB may use the MBS interest indication information, together with the information about the UE's capabilities (e.g., supported band combinations), when providing an RRC configuration and/or downlink assignments to the UE or to release data radio bearer (DRBs)/multicast MRBs, to allow the UE to receive the MBS services the UE is interested in. In one embodiment, the MBS interest indication information may be exchanged between a source gNB and a target gNB during a handover.

A handover (HO), also referred to as cell switch or cell change, enables mobility for the UE in RRC_CONNECTED state. There are several HO procedures. The network may initiate the HO via higher layer signaling, e.g. RRC message, based on L3 (Layer 3) measurements However, this procedure involves more latency, signaling overhead and interruption time that may become a key issue in scenarios with frequent handover, e.g., earth moving cell of NTN, UE in high-speed vehicle and in FR2 deployment, etc. To reduce overhead, latency and/or interruption time in HO, L1/L2 (Layer 1/Layer 2) signaling based on L1 measurement may trigger the HO using a mechanism referred to as a L1/L2 Triggered Mobility (LTM) procedure. In LTM, a UE switches from the source cell to a target cell with beam switching triggered by L1/L2 signaling, where the beam switching decision is based on L1 measurement on beams among neighboring cells.

In another HO procedure, referred to as a conditional handover (CHO) procedure, a serving gNB of a UE may configure the UE with configuration(s) of CHO candidate cell(s) and execution conditions(s). An execution condition may include one or more triggering condition(s) that the UE may evaluate to determine whether the UE will execute a handover procedure to switch from the serving cell to one of the CHO candidate cells.

For HO, LTM, CHO, the UE may perform L1 measurement on pre-configured RS resources of the candidate cells for mobility. The UE may report CSI measurement results to the network. Based on the reported CSI measurement results, the network may decide a target cell for cell switch and/or adjust resource allocation and PHY/MAC parameters for DL/UL transmission on the target cell. The UE may report the measurement results on a periodic, semi-persistent, or aperiodic basis. The UE may report the measurement results before, during, or immediately after the LTM cell switch, namely early CSI reporting. The network may activate CSI resource for candidate cells before the actual report. For example, the network may activate early CSI measurement and reporting for periodic, semi-persistent or aperiodic CSI resources.

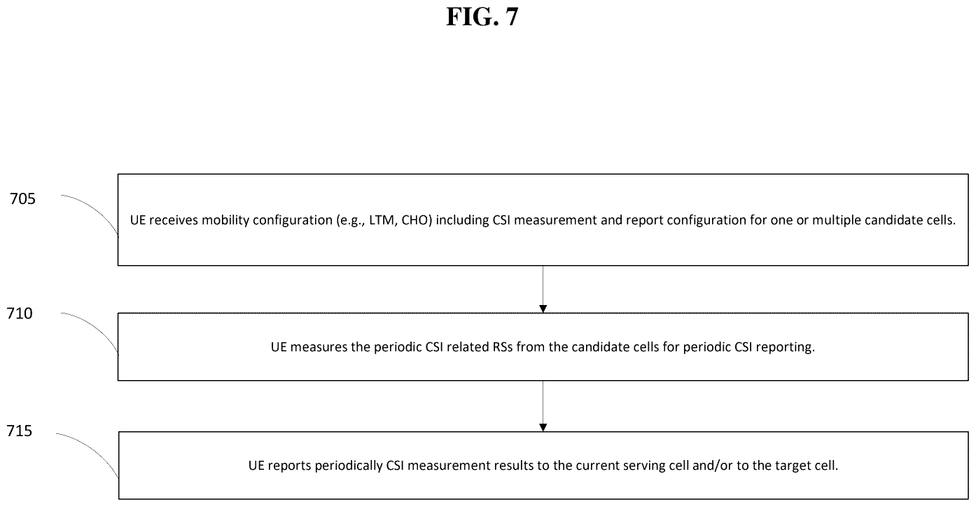

FIG. 7 shows a procedure for a UE to implement periodic early CSI reporting in accordance with an embodiment.

In operation 705, the network transmits mobility configuration (e.g., LTM, CHO) to the UE in a RRCReconfiguration message. The mobility configuration may include CSI measurement and report configuration for one or multiple candidate cells of the mobility target. The UE receives the mobility configuration (e.g., LTM) including the CSI measurement and report configuration for one or multiple candidate cells of the mobility target.

In operation 710, the network transmits periodically the CSI-related reference signals (RSs) on the candidate cells for periodic CSI reporting. Before cell switch or handover to the target cell, i.e., one of the candidate cells, the UE measures the periodic CSI-related RSs from the candidate cells for periodic CSI report.

In operation 715, the UE reports periodically CSI measurement results for the candidate cells to the current serving cell before handover/switching to the target cell and/or report CSI measurement results to the target cell during or after handover/switch to the target cell. The network receives the periodic CSI reports. The network decides a target cell from the candidate cells and/or adjusts resource allocation and PHY/MAC parameters for DL/UL transmissions on the target cell based on the periodic CSI reports.

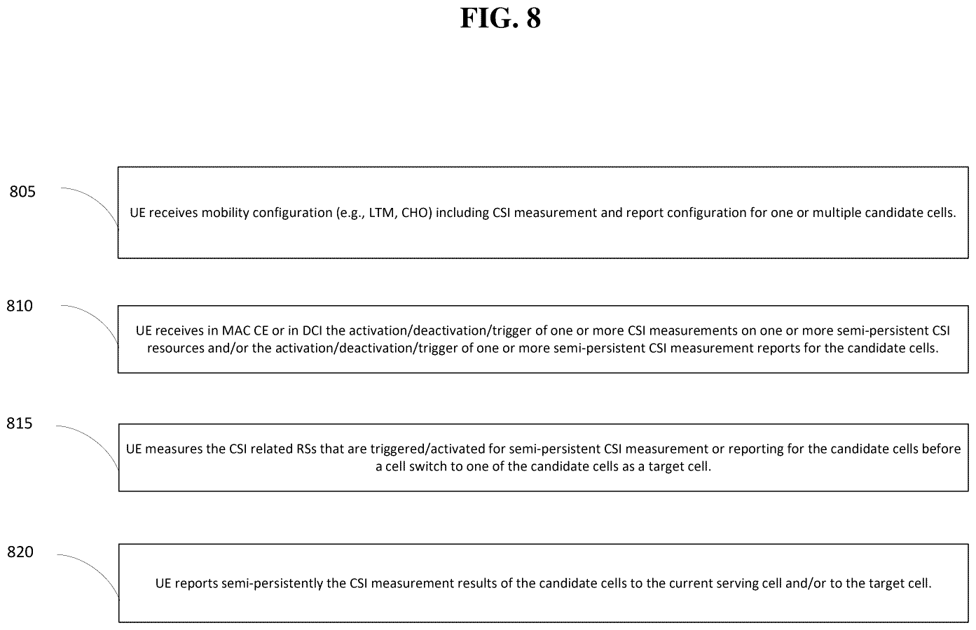

FIG. 8 shows a procedure for a UE to implement semi-persistent early CSI reporting in accordance with an embodiment.

In operation 805, the network transmits mobility configuration (e.g., LTM, CHO) to the UE in a RRCReconfiguration message. The mobility configuration may include CSI measurement and report configuration for one or multiple candidate cells of the mobility target. The UE receives the mobility configuration (e.g., LTM) including the CSI measurement and report configuration for one or multiple candidate cells of the mobility target.

In operation 810, before triggering cell switch or handover to the target cell, i.e., one of the candidate cells, the network transmits to the UE medium access control-control element(s) (MAC CE(s)) or downlink control information (DCI) to activate, deactivate, or trigger CSI resource measurement/report for one or multiple candidate cells. The MAC CEs or DCI may activate/trigger CSI measurement(s) on semi-persistent CSI resource(s) for CSI and/or activate/trigger semi-persistent CSI measurement report(s) for the candidate cells. The UE receives the MAC CE(s) or DCI for semi-persistent CSI resource measurement or semi-persistent CSI report activation/deactivation/trigger for the candidate cells.

In operation 815, the network transmits periodically or semi-persistently the CSI-related RSs on the candidate cells. Before cell switch or handover to the target cell, i.e., one of the candidate cells, the UE measures the transmitted CSI-related RSs that are triggered/activated for semi-persistent CSI measurement or reporting for the candidate cells.

In operation 820, the UE reports semi-persistently the CSI measurement results of the candidate cells to the current serving cell and/or to the target cell before or during or after the switch to the target cell. The network receives the semi-persistent CSI reports. The network decides a target cell from the candidate cells and/or adjusts resource allocation and PHY/MAC parameters for DL/UL transmissions on the target cell based on the semi-persistent CSI reports.

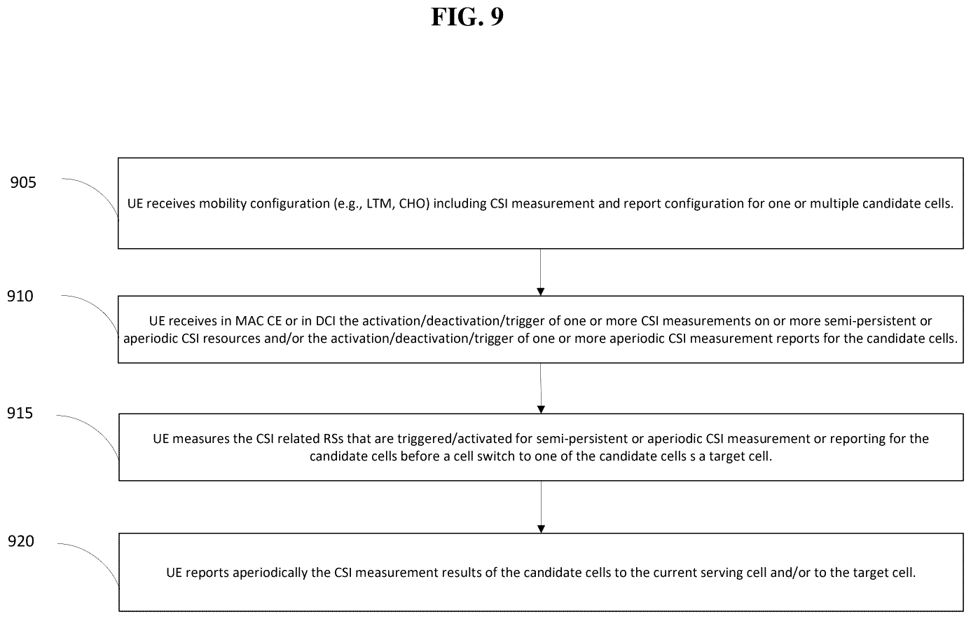

FIG. 9 shows a procedure for a UE to implement aperiodic early CSI reporting in accordance with an embodiment.

In operation 905, the network transmits mobility configuration (e.g., LTM, CHO) to the UE in a RRCReconfiguration message. The mobility configuration may include CSI measurement and report configuration for one or multiple candidate cells of the mobility target. The UE receives the mobility configuration (e.g., LTM) including the CSI measurement configuration for one or multiple candidate cells of the mobility target.

In operation 910, before triggering cell switch or handover to the target cell, i.e., one of the candidate cells, the network transmits to UE MAC CE(s) or DCI to activate, deactivate, or trigger CSI resource measurement/report for one or multiple candidate cells. The MAC CEs or DCI may activate/trigger CSI measurement(s) on semi-persistent or aperiodic CSI resource(s) and/or activate/trigger aperiodic CSI measurement report(s) for the candidate cells. The UE receives the MAC CE(s) or DCI for semi-persistent or aperiodic CSI resource measurement or aperiodic CSI report activation/deactivation/trigger for the candidate cells.

In operation 915, the network transmits periodically or semi-persistently or a-periodically the CSI-related RSs on the candidate cells. Before cell switch or handover to the target cell, i.e., one of the candidate cells, the UE measures the transmitted CSI-related RSs that are triggered/activated for semi-persistent or aperiodic CSI measurement or reporting for the candidate cells.

In operation 920, the UE reports on an aperiodic basis the CSI measurement results of the candidate cells to the current serving cell and/or to the target cell before or during or after the switch to the target cell. The network receives the aperiodic CSI report(s). The network decides a target cell from the candidate cells and/or adjusts resource allocation and PHY/MAC parameters for DL/UL transmissions on the target cell based on the aperiodic CSI report(s).

In one embodiment, with reference to operation 705 of FIG. 7, operation 805 of FIG. 8, or 905 of FIG. 9, the mobility configuration (e.g., LTM configuration) may add, modify, or release one or more lists of CSI-RS resource (sets). The lists of CSI-RS resource (sets) may include one or more of non-zero power (NZP) CSI-RS resource (sets), zero power (ZP) CSI-RS resource (sets), CSI-synchronization signal block (SSB) resource (sets), and/or CSI-interference measurement (IM) resource (sets). Each CSI-RS resource (sets) may be associated with a candidate cell ID. A configuration of CSI resources, referred to as a CSI resource configuration, identified by a CSI resource configuration ID, may include a list of CSI resource (sets) (e.g., NZP-CSI-RS/CSI-IM/ZP-CSI-RS resource or resource sets), the associated candidate cell ID, the candidate cell bandwidth part (BWP) ID, and/or the CSI resource type in terms of periodic, semi-persistent, or aperiodic CSI resources.

In one embodiment, with reference to operation 705 of FIG. 7, operation 805 of FIG. 8, or 905 of FIG. 9, the current serving cell's CSI measurement configuration may add, modify, or release one or more lists of CSI report configurations for candidate cells for mobility (e.g., LTM). Similarly, the mobility configuration (e.g., LTM configuration) for each candidate cell may add, modify, or release one or more lists of CSI report configurations for the candidate cell for mobility. Each CSI report configuration may be identified by a CSI report configuration ID. A CSI report configuration may include at least an associated CSI resource configuration, report type in terms of periodic, semi-persistent, or aperiodic, physical uplink control channel (PUCCH) or physical uplink shared channel (PUSCH) resource for periodic/semi-persistent report, report quantity, codebook type (e.g., type-I codebook, type-II codebook, etc.), frequency domain configuration (e.g., sub-band or wideband), time domain configuration (e.g., offset with respect to the report triggering time), and/or configuration to enable/disable group-based beam reporting on the RS(s).

In one embodiment, with reference to operation 810 of FIG. 8 or operation 910 of FIG. 9, the MAC CE to activate, deactivate, or trigger semi-persistent or aperiodic CSI resource measurement/report for one or multiple candidate cells for mobility (e.g., LTM), referred to as CSI resource set activation/deactivation MAC CE, may be identified by a MAC subheader with logical channel identity (LCID) or eLCID. CSI resource set activation/deactivation MAC CE may have a variable size and may consist of one or more fields.

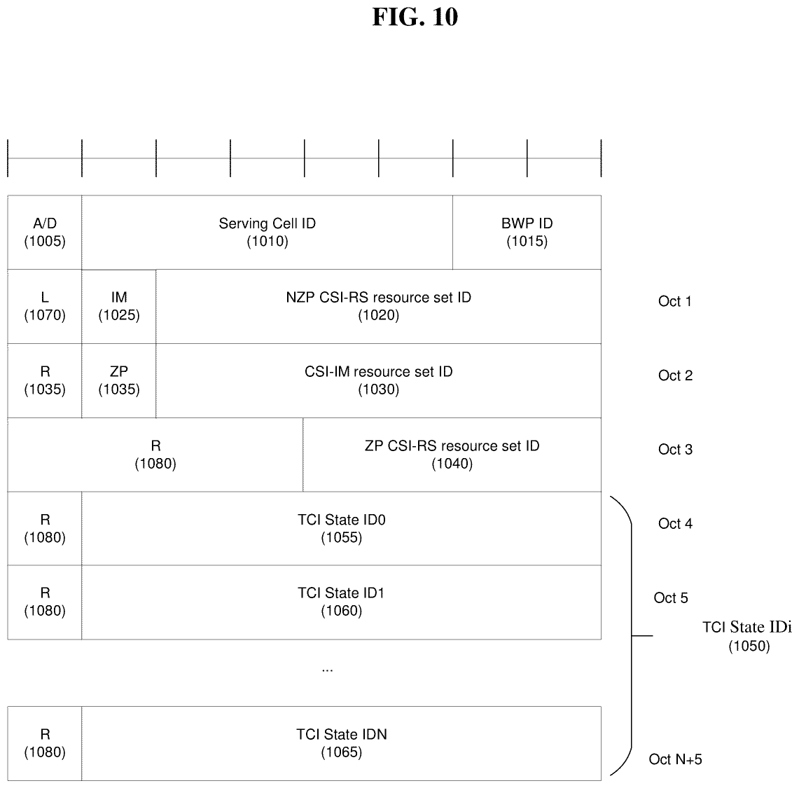

FIG. 10 shows fields of the CSI resource set activation/deactivation MAC CE in accordance with an embodiment.

The fields may include one or multiple of the following items:
A/D field (1005): This field indicates whether to activate or deactivate indicated CSI resource set(s). The field is set to 1 to indicate activation, otherwise it indicates deactivation;
Serving Cell ID (or candidate cell ID) (1010): This field indicates the identity of the serving cell for which the MAC CE applies. The length of the field is 5 bits; In another example, this field indicates the LTM candidate cell identity, corresponding to ltm-CandidateId minus 1, for which the MAC CE applies;
BWP ID (1015): This field indicates a DL BWP for which the MAC CE applies as the codepoint of the DCI bandwidth part indicator field. The length of the BWP ID field is 2 bits;
NZP CSI-RS resource set ID (1020): This field contains an index of NZP-CSI-RS-ResourceSet containing NZP CSI-RS resources (periodic, or semi persistent, or aperiodic), indicating the semi persistent NZP CSI-RS resource set that is activated or deactivated for the mobility candidate cell. The length of the field is 6 bits;
IM (1025): This field indicates the presence of the octet containing CSI-IM resource set ID field. If the IM field is set to 1, the octet containing CSI-IM resource set ID field is present. If IM field is set to 0, the octet containing CSI-IM resource set ID field is not present;
CSI-IM resource set ID (1030): This field contains an index of CSI-IM-ResourceSet containing CSI-IM resources (periodic, or semi persistent, or aperiodic), indicating the CSI-IM resource set that is activated or deactivated for the mobility candidate cell. The length of the field is 6 bits;
ZP (1035): This field indicates the presence of the octet containing ZP-CSI-RS resource set ID field. If the ZP field is set to 1, the octet containing ZP-CSI-RS resource set ID field is present. If ZP field is set to 0, the octet containing ZP-CSI-RS resource set ID field is not present;
ZP CSI-RS resource set ID (1040): This field contains the indication of ZP-CSI-RS-ResourceSet containing ZP CSI-RS resources (periodic, or semi persistent, or aperiodic) that are activated or deactivated for the mobility candidate cell. The length of the field is 4 bits;
TCI State IDᵢ (1050): This field contains TCI-StateId of a transmission configuration indicator (TCI State) that is used as quasi co-location (QCL) source for the resource within the NZP CSI-RS resource set (periodic, or semi persistent, or aperiodic) to be activated as indicated by NZP-CSI-RS resource set ID field. TCI State ID₀ (1055) indicates TCI State for the first resource within the set, TCI State ID₁ (1060) for the second one, . . . TCI State ID_{N} (1065) for the N^{th} one and so on. The length of the field is 7 bits. If the A/D field is set to 0, the octets containing TCI State ID field(s) are not present;
L (1070): This field indicates whether the MAC CE applies to CSI resource for LTM or not. If CSI acquisition/measurement/report configuration for LTM candidate cell(s) is not configured, R field is present instead (i.e. set to 0);
R (1080): Reserved bit, set to 0.

In one embodiment, a CSI resource configuration ID may be included in the MAC CE to indicate one or multiple configured NZP-CSI-RS/CSI-IM/ZP-CSI-RS resource or resource sets to be activated/deactivated/triggered for semi-persistent or aperiodic CSI measurement or reporting. The configured NZP-CSI-RS/CSI-IM/ZP-CSI-RS resource sets for mobility candidate cells are initially deactivated upon (re-)configuration by upper layers and after reconfiguration with sync or cell switch. In one example, the CSI resource set(s) with index(es) indicated in the MAC CE is activated, and the CSI resource set(s) with index(es) configured by RRC but not indicated in the MAC CE is deactivated. If the MAC entity receives an CSI resource set activation/deactivation MAC CE on a serving cell for mobility (e.g., LTM), the UE indicates to lower layers the information regarding the CSI resource set activation/deactivation MAC CE for mobility.

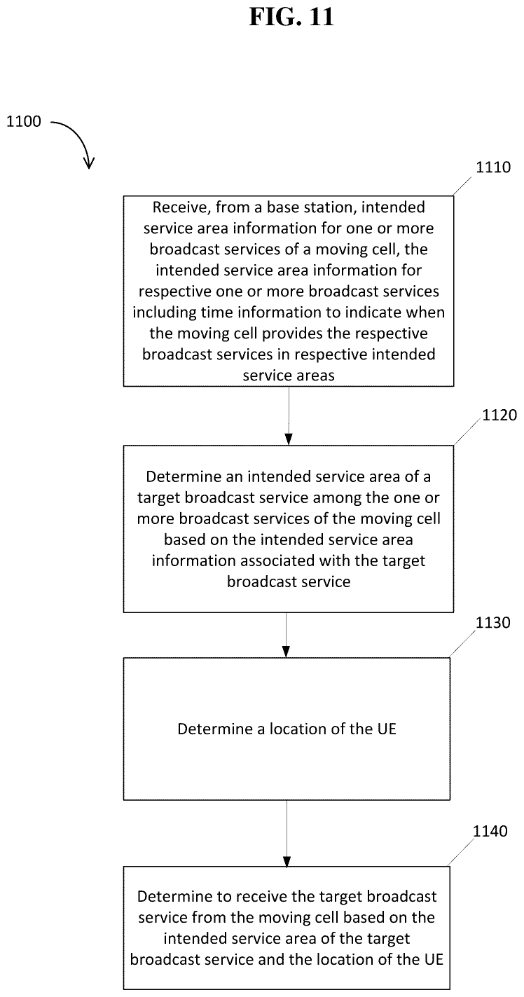

FIG. 11 shows an example process 1100 for a UE to receive MBS broadcast service from the base station of a moving cell based on the UE location and the intended service area of the MBS broadcast service in accordance with an embodiment. For explanatory and illustration purposes, the example processes 1100 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods

Referring to FIG. 11, the process 1100 may begin in operation 1110. In operation 1110, a UE (e.g., a processor of the UE) receives, from a base station, intended service area information for one or more broadcast services of a moving cell. The intended service area information for the respective broadcast services includes time information to indicate when the moving cell provides the respective broadcast services in the respective intended service areas. In one embodiment, the intended service area information for a broadcast service indicates the intended service time during which the moving cell broadcasts the broadcast service for the intended service area.

In operation 1120, the UE determines an intended service area of a target broadcast service among the one or more broadcast services of the moving cell based on the intended service area information associated with the target broadcast service. In one embodiment, the UE determines an intended service time interval associated with the intended service area of the target broadcast service.

In operation 1130, the UE determines a location of the UE.

In operation 1140, the UE determines to receive the target broadcast service from the moving cell based on the intended service area of the target broadcast service and the location of the UE. In one embodiment, the UE receives the target broadcast service when the UE is inside the intended service area of the target broadcast service and a current time is within an intended service time of the target broadcast service. Otherwise, the UE does not receive the target broadcast service.

The disclosure presents signalling designs for configuring intended service area for an earth moving cell in NTN. Additionally, the disclosure presents methods for a UE to receive MBS broadcast service in an intended service area for an earth moving cell in NTN. In one embodiment, intended service area information for an MBS broadcast service includes geographic area information and service time information. The UE may receive the MBS broadcast service when the UE is inside the geographic intended service area and a measured time is within the intended service time.

In one embodiment, the earth moving cell is characterized by coverage area center coordinates at a reference time and a coverage area radius. The UE may determine the real-time cell coverage area for the earth moving cell based on the coverage area center coordinates at the reference time, the satellite ephemeris associated with the cell, and the coverage area radius. The UE may receive the MBS broadcast service from the earth moving cell when the UE is inside the intended service area and also in the real-time cell coverage area for the earth moving cell.

In one embodiment, the intended service area of the MBS broadcast service for an earth moving cell is characterized by center coordinates at a reference time and a radius. The UE may determine the real-time intended service area of the MBS broadcast based on the center coordinates at a reference time, the satellite ephemeris associated with the earth moving cell, and the radius. The UE may receive the MBS broadcast service when the UE is inside ethe real-time intended service area.

Advantageously, using the disclosed signalling design for the intended MBS broadcast service area for an earth moving cell, the broadcast information can be tailored to some UEs in a certain area within an NTN earth moving cell when the intended broadcast area is smaller than an NTN cell coverage area.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) in a wireless network, the UE comprising:
a processor configured to:
receive, from a base station, intended service area information for one or more broadcast services of a moving cell, the intended service area information for respective one or more broadcast services including time information to indicate when the moving cell provides the respective broadcast services in respective intended service areas;
determine an intended service area of a target broadcast service among the one or more broadcast services of the moving cell based on the intended service area information associated with the target broadcast service;
determine a location of the UE; and
determine whether to receive the target broadcast service from the moving cell based on the intended service area of the target broadcast service and the location of the UE.

2. The UE of claim 1, wherein to determine the intended service area of the target broadcast service, the processor is configured to:
determine a time interval when the moving cell provides the target broadcast service in a geographic area based on the intended service area information for the target broadcast service.

3. The UE of claim 2, wherein to determine whether to receive the target broadcast service from the moving cell, the processor is configured to:
determine the location of the UE is within the geographic area of the target broadcast service;
determine a current time is within the time interval; and
receive the target broadcast service.

4. The UE of claim 2, wherein to determine whether to receive the target broadcast service from the moving cell, the processor is configured to:
determine the location of the UE is outside the geographic area of the target broadcast service or a current time is outside the time interval; and
refrain from receiving the target broadcast service.

5. The UE of claim 1, wherein the intended service area information for the one or more broadcast services comprises cell coverage area information of the moving cell, wherein the cell coverage area information comprises:
a center location of the cell coverage area at a reference time; and
a radius of the cell coverage area.

6. The UE of claim 5, wherein to determine the intended service area of the target broadcast service, the processor is configured to:
determine a center location of the cell coverage area at a target time based on the center location of the cell coverage area at the reference time and satellite ephemeris data associated with the moving cell; and
determine the cell coverage area at the target time based on the center location of the cell coverage area at the target time and the radius of the cell coverage area.

7. The UE of claim 6, wherein to determine whether to receive the target broadcast service from the moving cell, the processor is configured to:
determine the location of the UE is within the intended service area of the target broadcast service at the target time;
determine the location of the UE is within the cell coverage area at the target time; and
receive the target broadcast service at the target time.

8. The UE of claim 6, wherein to determine whether to receive the target broadcast service from the moving cell, the processor is configured to:
determine the location of the UE is outside the intended service area of the target broadcast service at the target time or outside the cell coverage area at the target time; and
refrain from receiving the target broadcast service at the target time.

9. The UE of claim 1, wherein the intended service area information for the respective one or more broadcast services comprises:
a center location of a geographic area of the respective one or more broadcast services at a reference time; and
a radius of the geographic area of the respective one or more broadcast services.

10. The UE of claim 9, wherein to determine the intended service area of the target broadcast service, the processor is configured to:
determine a center location of the geographic area of the target broadcast service at a target time based on the center location of the geographic area of the target broadcast service at the reference time and satellite ephemeris data associated with the moving cell; and
determine the geographic area of the target broadcast service at the target time based on the center location of the geographic area of the target broadcast service at the target time and the radius of the geographic area of the target broadcast service.

11. A method performed by a user equipment (UE) in a wireless network, the method comprising:
receiving, from a base station, intended service area information for one or more broadcast services of a moving cell, the intended service area information for respective one or more broadcast services including time information to indicate when the moving cell provides the respective broadcast services in respective intended service areas;
determining an intended service area of a target broadcast service among the one or more broadcast services of the moving cell based on the intended service area information associated with the target broadcast service;
determining a location of the UE; and
determining whether to receive the target broadcast service from the moving cell based on the intended service area of the target broadcast service and the location of the UE.

12. The method of claim 11, wherein determining the intended service area of the target broadcast service comprise:
determining a time interval when the moving cell provides the target broadcast service in a geographic area based on the intended service area information for the target broadcast service.

13. The method of claim 12, wherein determining whether to receive the target broadcast service from the moving cell comprises:
determining the location of the UE is within the geographic area of the target broadcast service;
determining a current time is within the time interval; and
receiving the target broadcast service.

14. The method of claim 12, wherein determining whether to receive the target broadcast service from the moving cell comprises:
determining the location of the UE is outside the geographic area of the target broadcast service or a current time is outside the time interval; and
refraining from receiving the target broadcast service.

15. The method of claim 11, wherein the intended service area information for the one or more broadcast services comprises cell coverage area information of the moving cell, wherein the cell coverage area information comprises:
a center location of the cell coverage area at a reference time; and
a radius of the cell coverage area.

16. The method of claim 15, wherein determining the intended service area of the target broadcast service comprise:
determining a center location of the cell coverage area at a target time based on the center location of the cell coverage area at the reference time and satellite ephemeris data associated with the moving cell; and
determining the cell coverage area at the target time based on the center location of the cell coverage area at the target time and the radius of the cell coverage area.

17. The method of claim 16, wherein determining whether to receive the target broadcast service from the moving cell comprises:
determining the location of the UE is within the intended service area of the target broadcast service at the target time;
determining the location of the UE is within the cell coverage area at the target time; and
receiving the target broadcast service at the target time.

18. The method of claim 16, wherein determining whether to receive the target broadcast service from the moving cell comprises:
determining the location of the UE is outside the intended service area of the target broadcast service at the target time or outside the cell coverage area at the target time; and
refraining from receiving the target broadcast service.

19. The method of claim 11, wherein the intended service area information for the respective one or more broadcast services comprises:
a center location of a geographic area of the respective one or more broadcast services at a reference time; and
a radius of the geographic area of the respective one or more broadcast services.

20. The method of claim 19, wherein determining the intended service area of the target broadcast service comprise:
determining a center location of the geographic area of the target broadcast service at a target time based on the center location of the geographic area of the target broadcast service at the reference time and satellite ephemeris data associated with the moving cell; and
determining the geographic area of the target broadcast service at the target time based on the center location of the geographic area of the target broadcast service at the target time and the radius of the geographic area of the target broadcast service.
